(19) United States
(12) Patent Application Publication
(10) Pub. No.: US 2010/0225458 A1
(43) Pub. Date: Sep. 9, 2010

(54) BICYCLE BURGLARPROOF DEVICE

(75) Inventor: En-Min Jow, HSINCHU (TW)

Correspondence Address: ROSENBERG, KLEIN & LEE, 3458 ELLICOTT CENTER DRIVE-SUITE 101, ELLICOTT CITY, MD, 21043, US

(73) Assignee: APTOS TECHNOLOGY INC., MIAOLI COUNTY (TW)

(21) Appl. No.: 12/547,782

(22) Filed: Aug. 26, 2009

(30) Foreign Application Priority Data
Mar. 4, 2009 (TW) 98205449

(51) Int. Cl. B62J 6/00

(52) U.S. Cl. 340/432

(57) ABSTRACT

A bicycle burglarproof device includes a monitoring device and a warning device. The monitoring device detects a displacement of a bicycle, and wirelessly transmits a warning signal to the warning device once the displacement is identified as abnormal. Upon receiving the warning signal, the warning device notifies a user that an anomalous situation has happened via a recognizable signal generated by a prompting unit. The bicycle burglarproof device is capable of notifying the remote owner of the bicycle via a wireless communication module once an abnormal displacement of the bicycle is detected, so that the owner can immediately act to stop the burglary. In addition, the monitoring device is compactly designed and may be easily integrated with other bicycle accessories, so that it is less likely to catch the attention of burglars and get destroyed, thereby constant communication with the warning device may be maintained.

### BACKGROUND OF THE INVENTION

1. Field of the Invention

The present invention is related to a burglarproof device, and more particularly to a bicycle burglarproof device.

2. Description of the Prior Art

Petrochemical fuel contains nonrenewable energy, which may run out. Also, burning petrochemical fuel results in exhaust emission which pollutes the air and even becomes one of the primary causes of global warming. With the promotion of environmental protection and outdoor recreation, a bicycle becomes a popular transportation for a short course.

Because bicycles are relatively small in volume with high-unit-price ones especially light in weight and easy to disassemble, they usually become the target for burglars. Burglarproof locks currently available in the market are usually disposed at a conspicuous position and lock a tire of a bicycle; however, conventional burglarproof locks are easily destroyed, and hence cannot achieve effective burglarproof.

According to the foregoing description, to provide a bicycle burglarproof device to prevent burglary is a current goal to be achieved.

### SUMMARY OF THE INVENTION

The present invention is directed to providing a bicycle burglarproof device comprising a sensing unit configured to detect an abnormal displacement of a bicycle and a wireless communication module configured to notify the remote owner of the bicycle once the abnormal displacement of the bicycle is detected, so that the owner may immediately act to stop the burglary. In addition, the compactness of the burglarproof device of the present invention allows it to be hidden and integrated with other bicycle accessories easily, so that it is less likely to catch a burglar's attention and get destroyed, and may maintain a sustained communication with the owner of the bicycle.

A bicycle burglarproof device according to one embodiment includes a monitoring device arranged on a bicycle and a warning device. The monitoring device comprises a sensing unit, a first controller, a first wireless communication module and a first power module. The sensing unit is configured to detect a displacement of the bicycle. The first controller is electrically connected to the sensing unit for outputting a warning signal when the displacement is identified as abnormal by the first controller. The first wireless communication module is electrically connected to the first controller for wirelessly transmitting the warning signal. The first power module supplies the required power to the monitoring device. The warning device comprises a second wireless communication module, a prompting unit, a second controller and a second power module. The second wireless communication module is configured to wirelessly receive the warning signal transmitted from the monitoring device. The prompting unit is configured for generating a user recognizable signal. The second controller is electrically connected to the second wireless communication module and the prompting unit for controlling the prompting unit to notify the user of an anomalous situation according to the warning signal. The second power module supplies the required power to the warning device.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a block diagram schematically illustrating a bicycle burglarproof device according to one embodiment of the present invention; and

FIG. 2 is a block diagram schematically illustrating a bicycle burglarproof device according to another embodiment of the present invention.

### DESCRIPTION OF THE PREFERRED EMBODIMENT

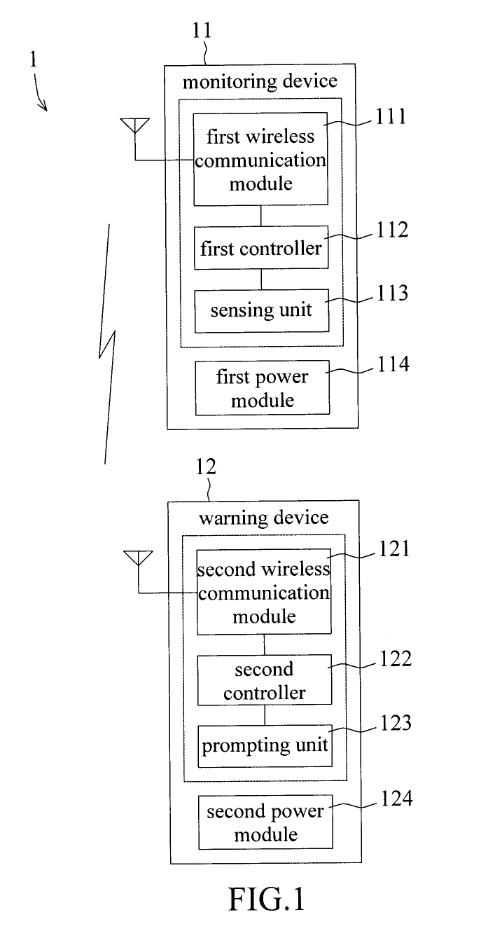

Referring to FIG. 1, a bicycle burglarproof device 1 comprises a monitoring device 11 arranged on a bicycle and a warning device 12. The monitoring device 11 comprises a sensing unit 113, a first controller 112, a first wireless communication module 111 and a first power module 114. The sensing unit 113 is configured to detect a displacement of the bicycle. In one embodiment, the sensing unit 113 comprises an acceleration sensor which is capable of detecting a physical quantity such as the displacement of the bicycle when it is moved or pushed over, or the vibration caused when a conventional burglarproof lock is being destroyed.

The first controller 112 is electrically connected to the sensing unit 113 to identify whether the displacement detected by the sensing unit 113 is abnormal and when it is the case, the first controller 112 outputs a warning signal. The first wireless communication module 111 is electrically connected to the first controller 112 for wirelessly transmitting the warning signal outputted from the first controller 112. The first power module 114 supplies the required power to the monitoring device 11. For example, the first power module 114 may comprise a rechargeable battery or a disposable battery.

The warning device 12 comprises a second wireless communication module 121, a prompting unit 123, a second controller 122 and a second power module 124. The second wireless communication module 121 wirelessly receives the warning signal transmitted from the first wireless communication module 111. The prompting unit 123 is configured for generating a recognizable signal for a user, such as sound, light and vibration for hearing, vision and touching, respectively, and any combination of these forms of a signal. In one embodiment, the prompting unit 123 comprises a sound generator, light generator, a vibration generator or a combination thereof. For example, the prompting unit 123 may comprise a speaker, light emitting diode (LED), vibration motor, or a combination thereof.

The second controller 122 is electrically connected to the second wireless communication module 121 and the prompting unit 123. The second controller 122 is configured to control the prompting unit 123 to notify the user of an anomalous situation, such as a bicycle burglary, according to the warning signal transmitted from the monitoring device 11. The second power module 124 supplies the required power to the warning device 12. For example, the second power module 124 may comprise a rechargeable battery or a disposable battery. In one embodiment, the warning device 12 may be integrated with a mobile phone, personal digital assistant (PDA) or other portable electronic devices.

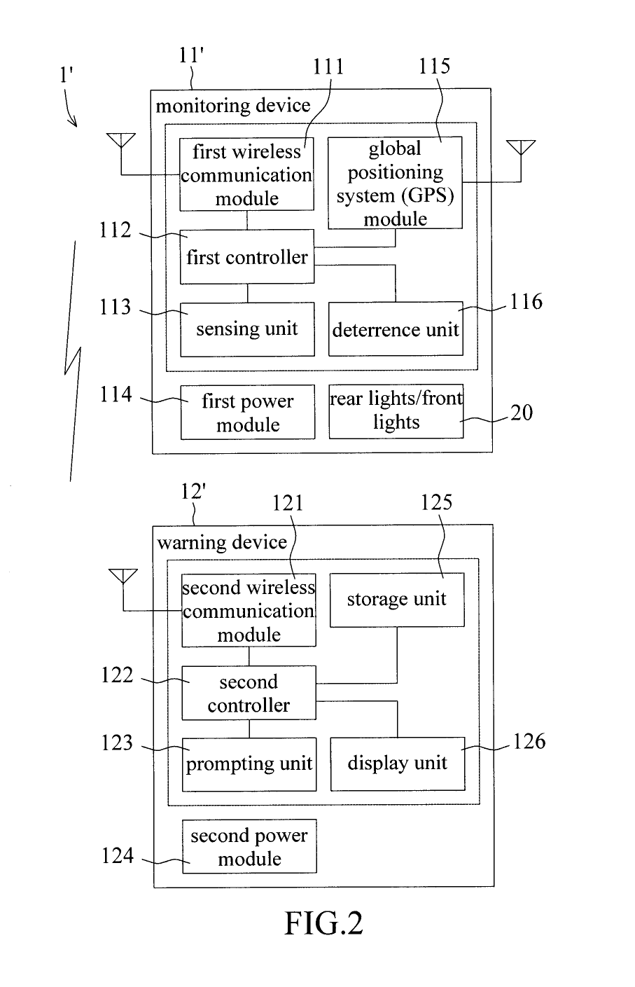

FIG. 2 illustrates a bicycle burglarproof device 1′ according to another embodiment of the present invention, wherein a monitoring device 11′ of the bicycle burglarproof device 1′ further comprises a global positioning system (GPS) module 115 electrically connected to the first controller 112. The GPS module 115 may receive a satellite signal to generate a position coordinate of the monitoring device 11′ at the current position. With the GPS module 115, the monitoring device 11′ wirelessly transmits not only a warning signal, but also a position coordinate generated by the GPS module 115 to a warning device 12′ when an abnormal displacement is detected by the sensing unit 113.

In continuation of the above descriptions, in one embodiment, the warning device 12′ further comprises a display unit 126 electrically connected to the second controller 122 for displaying the position coordinate transmitted by the monitoring device 11′. It should be noted that the display unit 126 may be an optional device. In one embodiment without the display unit 126, the warning device 12′ may notify the user of the current position of the bicycle via speech sounds. Besides, the warning device 12′ may also comprise a storage unit 125 electrically connected to the second controller 122. The storage unit 125 is configured to store the position coordinate transmitted by the monitoring device 11′ and the corresponding time stamp, so that the owner of the bicycle may trace the track of the stolen bicycle to recover it.

Referring to FIG. 2, the monitoring device 11′ further comprises a deterrence unit 116 electrically connected to the first controller 112. The deterrence unit 116 is configured to generate a recognizable signal for hearing and/or vision. For example, the deterrence unit 116 may comprise a speaker, a light emitting diode (LED) or the combination thereof. Therefore, the deterrence unit 116 of the monitoring device 11′ may generate sounds or lights to deter the burglar from stealing the bicycle.

It should be noted that in order to avoid the generated sounds or lights leading the burglar to destroy the monitoring device 11′ and continue stealing, the deterrence unit 116 may be optionally included or activated. Alternatively, in one embodiment, the monitoring device 11′ may be integrated with rear lights or front lights 20 of the bicycle. In other words, the monitoring device 11′ may be disguised in rear lights or front lights 20 of the bicycle to avoid the monitoring device 11′ from being destroyed before stealing.

In summary of the foregoing descriptions, a bicycle burglarproof device according to the present invention comprises a sensing unit configured to detect an abnormal displacement of a bicycle and a wireless communication module configured to notify the remote owner of the bicycle, so that the owner can immediately act to stop the burglary. In addition, a monitoring device of the present invention is compactly designed and may be easily hidden or integrated with other bicycle accessories so as to avoid being detected and destroyed by a burglar, and may constantly communicate with the warning device to help recovery of the stolen bicycle.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A bicycle burglarproof device comprising:
a monitoring device arranged on a bicycle, comprising:
a sensing unit configured to detect a displacement of said bicycle;
a first controller electrically connected to said sensing unit for outputting a warning signal when said displacement is identified as abnormal;
a first wireless communication module electrically connected to said first controller for wirelessly transmitting said warning signal; and
a first power module configured for supplying the required power to said monitoring device; and
a warning device comprising:
a second wireless communication module configured for wirelessly receiving said warning signal;
a prompting unit configured for generating a user recognizable signal;
a second controller electrically connected to said second wireless communication module and said prompting unit configured for controlling said prompting unit to notify said user of an anomalous situation according to said warning signal; and
a second power module configured for supplying the required power to said warning device.

2. A bicycle burglarproof device according to claim 1, wherein said monitoring device further comprises a global positioning system module, which is electrically connected to said first controller for generating a position coordinate.

3. A bicycle burglarproof device according to claim 2, wherein said warning device further comprises a storage unit, which is electrically connected to said second controller for storing said position coordinate and a corresponding time stamp.

4. A bicycle burglarproof device according to claim 2, wherein said warning device further comprises a display unit, which is electrically connected to said second controller for displaying said position coordinate.

5. A bicycle burglarproof device according to claim 1, wherein said detecting unit comprises an acceleration sensor.

6. A bicycle burglarproof device according to claim 1, wherein said monitoring device further comprises a deterrence unit, electrically connected to said first controller for generating a deterrence signal.

7. A bicycle burglarproof device according to claim 6, wherein said deterrence unit comprises a speaker, a light emitting diode (LED) or a combination thereof.

8. A bicycle burglarproof device according to claim 1, wherein said prompting unit comprises a sound generator, light generator, a vibration generator or a combination thereof.

9. A bicycle burglarproof device according to claim 1, wherein said prompting unit comprises a speaker, a light emitting diode (LED), a vibration motor or a combination thereof.

10. A bicycle burglarproof device according to claim 1, wherein said first power module and/or said second power module comprise a rechargeable battery or a disposable battery.

11. A bicycle burglarproof device according to claim 1, wherein said monitoring device is integrated with rear lights or front lights of said bicycle.

12. A bicycle burglarproof device according to claim 1, wherein said warning device is integrated with a mobile phone or a personal digital assistant (PDA).
